(19) United States
(12) Patent Application Publication
(10) Pub. No.: US 2015/0023753 A1
(43) Pub. Date: Jan. 22, 2015

(54) PLUG FOR CLOSING AN APERTURE DEFINED IN MACHINE COMPONENT

(71) Applicant: Caterpillar Inc., Peoria, IL (US)

(72) Inventors: Dimitar Borissov Dostinov, Fort Worth, TX (US); Lauritz Phillip Pillers, II, McGregor, TX (US)

(73) Assignee: Caterpillar Inc., Peoria, IL (US)

(21) Appl. No.: 14/510,218

(22) Filed: Oct. 9, 2014

(51) Int. Cl. F16B 31/00; F16B 35/04

(52) U.S. Cl. CPC F16B 31/00; F16B 35/04
USPC 411/2

(57) ABSTRACT

A plug for closing an aperture defined in a machine component includes a flange, a first portion, and a second portion. The first portion includes a first set of threads configured at a first pitch to engage with threads on the machine component, and a second set of threads configured at a second pitch to lock with the threads on the machine component and retain the first portion within the aperture. The second portion includes a neck portion, and a bolt head extending from the neck portion. The neck region is configured to withstand a pre-determined maximum torque load. The bolt head is operable to threadably engage the first set of threads and the second set of threads with the threads of the machine component and allow shearing of the neck portion if a torque applied on the bolt head exceeds the pre-determined maximum torque load.

### TECHNICAL FIELD

The present disclosure generally relates to a plug. More particularly, the present disclosure relates to a one-time usable plug for closing an aperture defined in a machine component.

### BACKGROUND

Many machine components are initially manufactured so as to define one or more apertures therein. However, one or more apertures may not be used depending on the end use of the machine component. For example, an engine block may be initially casted with a pair of apertures. However, one of the apertures may not be required for use depending on specific requirements of an application associated with an engine. Typically, plugs have been used to close off such apertures and many configurations and/or designs of such plugs have been developed in the past for accomplishing a closing of such apertures.

For reference, U.S. Pat. No. 3,595,124 (hereinafter referred to as the '124 Patent) discloses a controlled torque bolt having a threaded shank and a driving head that is integral with the threaded shank. The driving head is adapted to shear off the bolt upon the application of a predetermined torque upon the driving head. The bolt also includes an enlarged flange or head forming the head of the bolt, the driving head and the enlarged head being integral with the bolt so as to define a fold or undercut therebetween. The fold defines the plane of shear for the driving head upon application of the predetermined torque at the driving head.

Although previously known systems such as the torque bolt of '124 Patent are configured to shear off upon application of the predetermined torque, a portion of the bolt head may still be configured to remain back on the torque bolt so as to allow removal of the torque bolt from the machine component at a later time.

Also, it may be possible that with vibrations and other operational forces experienced during operation of the machine component, the threaded shank of the torque bolt may disengage itself from the machine component. As such, the '124 Patent does not disclose any mechanism to secure the bolt onto the machine component when the bolt is subject to vibrations and other operational forces of the machine component.

Hence, there is a need for a system that overcomes the aforementioned shortcomings

### SUMMARY OF THE DISCLOSURE

In an aspect of the present disclosure, a plug for closing an aperture defined in a machine component is provided. The plug is configured for use on a machine component that has threads of a uniform pitch adjoining the aperture. The plug includes a flange having a first side and a second side. The first side of the flange is configured to abut an outer surface of the machine component disposed adjacent to the aperture.

In another aspect of the present disclosure, the plug further includes a first portion extending axially away from the first side of the flange. The first portion includes a first set of threads configured at a first pitch, and a second set of threads configured at a second pitch that is different from the first pitch. The first set of threads is distally located from the first side of the flange and is configured to threadably engage with the threads on the machine component.

The second set of threads is continuously formed with the first set of threads and located proximal to the first side of the flange. The second set of threads are configured to lock with the threads on the machine component so as to retain the first portion within the aperture.

In yet another aspect of the present disclosure, the plug further includes a second portion extending axially away from the second side of the flange. The second portion includes a neck portion, and a bolt head. The neck portion is disposed on the second side of the flange and is configured to withstand a pre-determined maximum torque load thereon.

The bolt head extends from the neck portion. The bolt head is operable to threadably engage the first set of threads and the second set of threads with the threads of the machine component. The bolt head is further operable to allow shearing of the neck portion if a torque applied on the bolt head exceeds the maximum torque load.

Other features and aspects of this disclosure will be apparent from the following description and the accompanying drawings.

### BRIEF DESCRIPTION OF THE DRAWINGS

FIG. 1 is a front perspective view of a plug in accordance with aspects of the present disclosure;

FIG. 2 is a rear perspective view of the plug taken from FIG. 1;

FIG. 3 is a front perspective view of the plug employed to close an aperture defined in a machine component;

FIG. 4 is a partial break-away of the machine component taken along section line A-A′ of FIG. 3, the partial break-away view showing the plug closing the aperture of the machine component; and

FIG. 5 is a diagrammatic view of the plug showing a neck portion being sheared off during use and upon application of a torque exceeding a pre-determined maximum torque load.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims

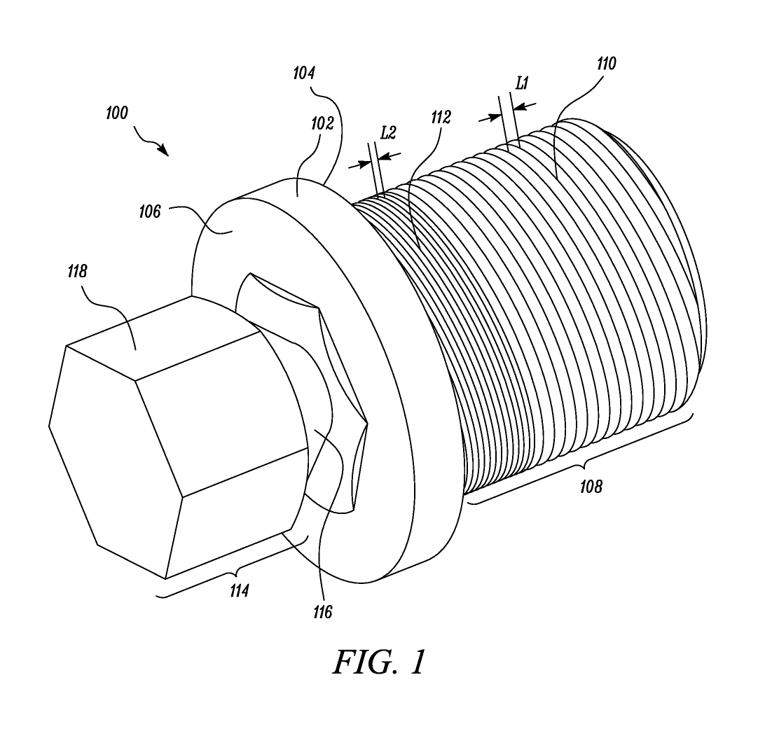

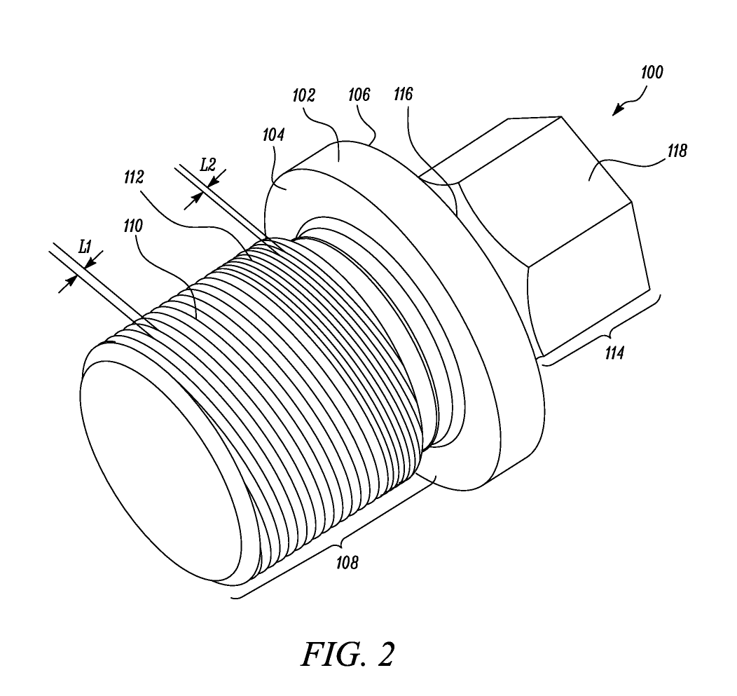

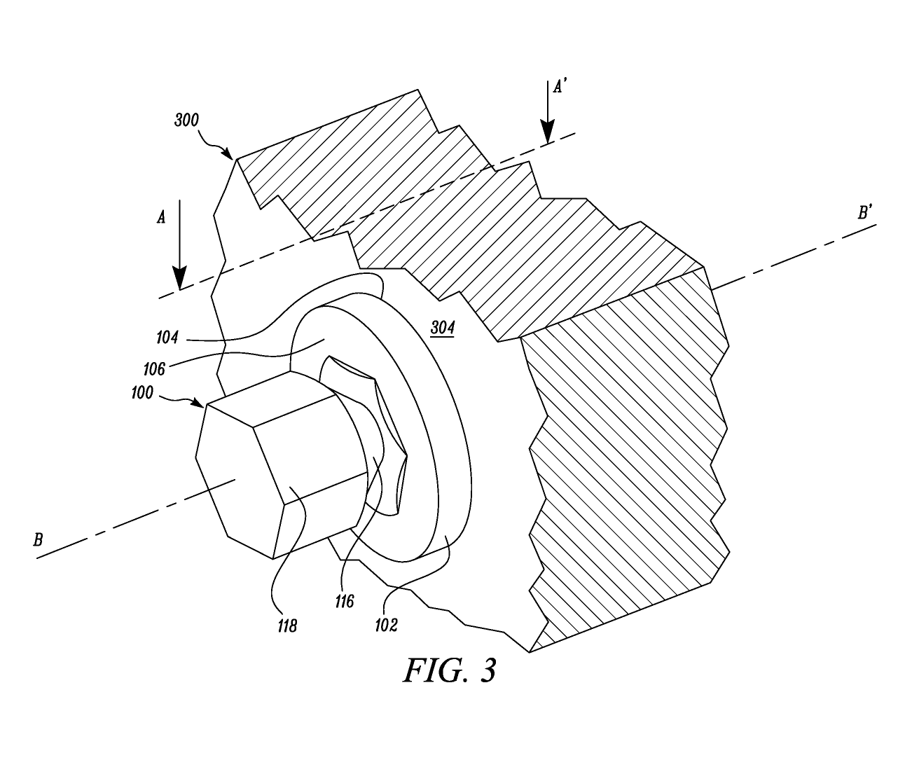

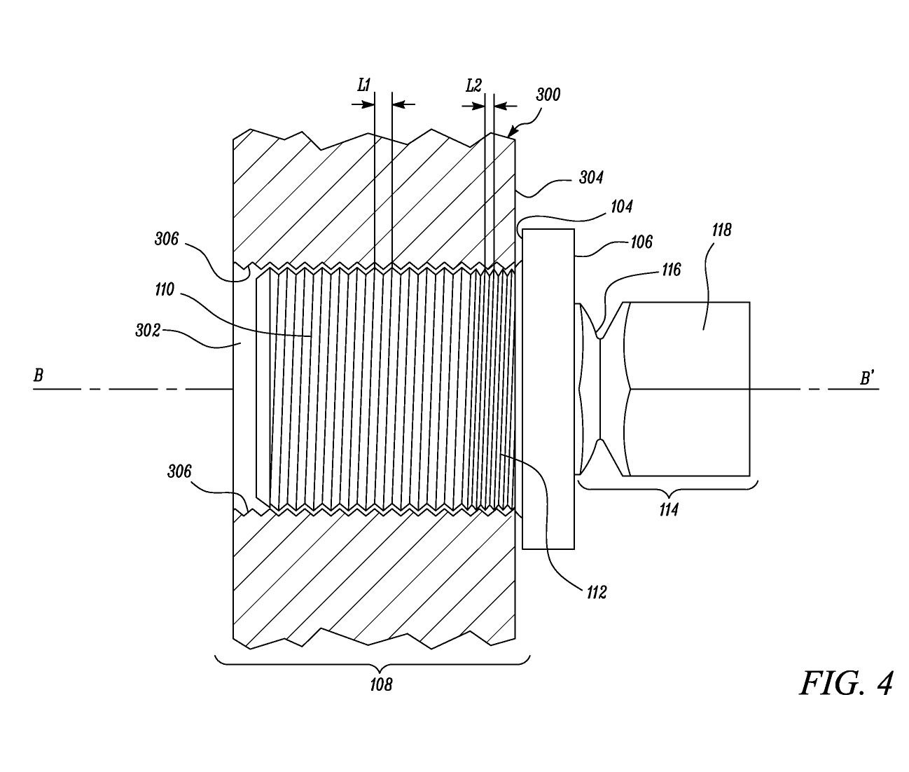

FIGS. 1 and 2 show a front perspective view and a rear perspective of a plug 100 in accordance with aspects of the present disclosure. Moreover, FIG. 3 shows a front perspective view of the plug 100 employed to close an aperture 302 defined in a machine component 300. FIG. 4 shows a partial break-away of the machine component 300 taken along section line A-A′ of FIG. 3, the partial break-away view showing the plug 100 closing the aperture 302 of the machine component 300. Explanation to the plug 100 and its manner of use with the machine component 300 will be made in conjunction with reference to FIGS. 1-4 hereinafter.

Referring to FIGS. 1 and 2, the plug 100 includes a flange 102 having a first side 104 and a second side 106. As shown in FIGS. 3-4, the first side 104 of the flange 102 is configured to abut an outer surface 304 of the machine component 300, wherein the outer surface 304 is disposed adjacent to the aperture 302. Referring to FIGS. 1-4, the plug 100 further includes a first portion 108 extending axially away from the first side 104 of the flange 102. The first portion 108 includes a first set of threads 110 configured at a first pitch L1, and a second set of threads 112 configured at a second pitch L2. The second pitch L2 is different from the first pitch L1. As illustrated, the second pitch L2 is less in magnitude than the first pitch L1. The first set of threads 110 is distally located from the first side 104 of the flange 102. The second set of threads 112 is continuously formed with the first set of threads 110 and located proximal to the first side 104 of the flange 102.

The first set of threads 110 and second set of threads 112 are configured to threadably engage with threads 306 of the machine component 300 (See FIG. 3). The threads 306 defined in the machine component 300 are of uniform pitch and are located adjoining the aperture 302. In an example, these threads 306 may be formed to have a pitch of 9/16″-18 i.e., with a configuration of 18 threads per inch and which has a nominal size of 9/16 inches. As such, these threads 306 of the machine component 300 correspond to a configuration of the first set of threads 110, explanation to which will be made hereinafter.

In an aspect of the present disclosure, it is contemplated to form the first set of threads 110 such that the first pitch L1 corresponds to a screw pitch size associated with the threads 306 of the machine component 300. This relative screw pitch sizing of the first set of threads 110 and the threads 306 allows a transition fit to be accomplished between the first set of threads 110 and the threads 306. However, the second pitch L2 of the second set of threads 112 is selected so as to allow the second set of threads 112 to accomplish an interference fit with the threads 306 of the machine component 300.

Also, it is additionally contemplated to select the first pitch L1 and the second pitch L2 of the first set of threads 110 and the second set of threads 112 such that the pitch sizes L1 and L2 lie numerically close to each other. For example, if the threads 306 on the machine component 300 have a pitch of 9/16″-18 i.e., with a configuration of 18 threads per inch and which has a nominal size of 9/16 inches, the first set of threads 110 may be formed to a screw pitch size of 9/16″-18 inches (Metric: M16×1.5) while the second set of threads 112 may be formed to a screw pitch size of 9/16″-19 inches (Metric: M16×1.3). This way, the first set of threads 110 can be configured to accomplish the transition fit with the threads on the machine component 300 while the second set of threads 112 can accomplish the interference fit with the threads 306 on the machine component 300.

Moreover, it should be noted that with reference to the present disclosure, it is contemplated to form the first set of threads 110 and the second set of threads 112 as similarly handed threads, for e.g., right-handed threads, or left-handed threads. Right-handed threading on the plug 100 may allow the plug 100 to tighten with clockwise rotation and loosen with an anti-clockwise rotation thereof. Left-handed threading on the plug 100 may allow the plug 100 to tighten with counter-clockwise rotation and loosen with clockwise rotation thereof. Such similar handing of the threads 110, 112 on the plug 100 is provided to allow engagement of the first set of threads 110 and the second set of threads 112 with the threads 306 of the machine component 300.

With continued reference to FIGS. 1 to 4, the plug 100 further includes a second portion 114 extending axially away from the second side 106 of the flange 102. The second portion 114 includes a neck portion 116 (as best seen in FIGS. 1, 3, and 4). As shown, the neck portion 116 is disposed on the second side 106 of the flange 102. The neck portion 116 is configured to withstand a pre-determined maximum torque load thereon, explanation to which will be made in conjunction with FIGS. 1-5.

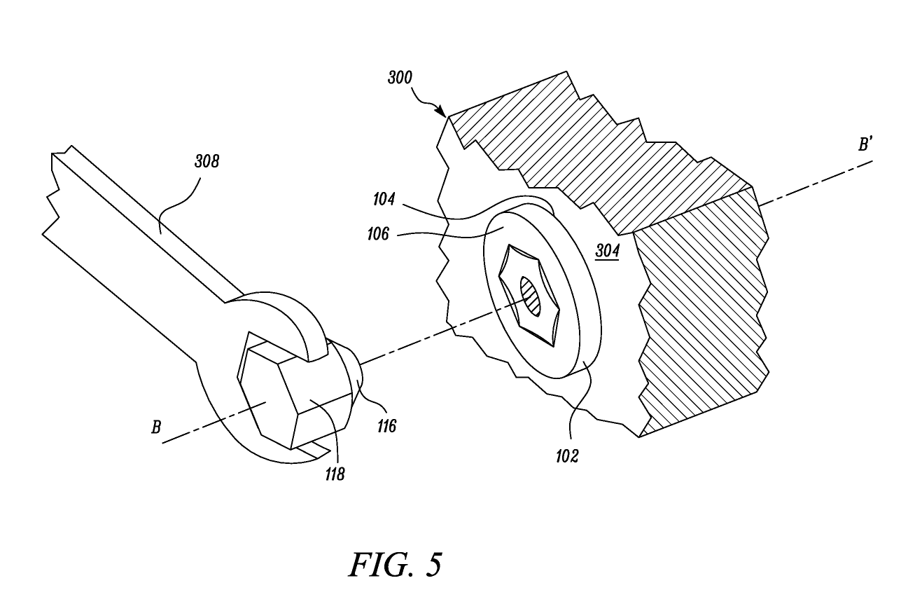

Referring to FIGS. 1-4, the second portion 114 of the plug 100 further includes a bolt head 118 extending from the neck portion 116. The bolt head 118 is operable to threadably engage the first set of threads 110 and the second set of threads 112 with the threads 306 of the machine component 300. Referring to FIG. 5, a diagrammatic view of the plug 100 is illustrated. During use of the plug 100 to close the aperture 302 in the machine component 300, one may engage a hand tool 308, for e.g., a wrench (as shown in FIG. 5) to the bolt head 118 of the plug 100 and rotate the plug 100 using the hand tool 308.

The rotation of the plug 100 may be carried out about a centric axis B-B′ (See FIGS. 4 and 5) of the aperture 302 so as to engage the first set of threads 110 of the plug 100 to the threads 306 of the machine component 300. During engagement of the first set of threads 110 of the plug 100 to the threads 306 of the machine component 300, the first set of threads 110 and the threads 306 of the machine component 300 undergo a transition fit on the basis of their relative screw pitch sizes as disclosed earlier herein.

Further rotation of the plug 100 relative to the machine component 300, i.e., about the centric axis B-B′ of the aperture 302, may bring about engagement of the second set of threads 112 of the plug 100 with the threads 306 of the machine component 300 (See FIGS. 4 and 5). The engagement of the second set of threads 112 on the plug 100 to the threads 306 of the machine component 300 can be regarded as an interference fit.

It is envisioned that an amount of torque required at the hand tool 308 for rotating the plug 100 in engaging the second set of threads 112 with the threads 306 of the machine component 300 will be greater than that required for engaging the first set of threads 110 to the threads 306 of the machine component 300. If the torque applied to the bolt head 118 for engaging the first set of threads 110 to the threads 306 of the machine component 300 is, for example, 20 Nm, then the torque required for engaging the second set of threads 112 to the threads 306 of the machine component 300 may be, for example, 60 Nm.

One of ordinary skill in the art will acknowledge that such greater amount of torque required for engaging the second set of threads 112 to the threads 306 of the machine component 300 is a result of the relative screw pitch sizing between the second set of threads 112 and the threads 306 of the machine component 300. However, such greater torque applied at the bolt head 118 beneficially secures the plug 100 in a frictional engagement and hence, accomplishes an interference fit of the plug 100 with the machine component 300.

The rotation of the plug 100 relative to the machine component 300 may be continued until the first side 104 of the flange 102 abuts the outer surface 304 of the machine component 300 (See FIGS. 3 and 4). In a further aspect of the present disclosure, the bolt head 118 is further operable to allow shearing of the neck portion 116 if the torque applied on the bolt head 118 exceeds the maximum torque load. In one example, the neck portion 116 may be configured to withstand a maximum torque load of 80 Nm thereon.

Referring to FIGS. 1, 3, 4, and 5, the neck portion 116 has a reduced diameter in comparison to the remainder of the plug 100 and can hence, be regarded as a constriction in the plug 100. As a result, the neck portion 116 manifests into a weakened region offering the pre-determined maximum torque load limit. Referring to FIGS. 4 and 5, after engaging the second set of threads 112 with the threads 306 of the machine component 300, if the torque applied on the bolt head 118 exceeds the maximum torque load i.e., say 80 Nm from the preceding examples, the neck portion 116 shears away from the flange 102 (See FIG. 5).

Various embodiments disclosed herein are to be taken in the illustrative and explanatory sense, and should in no way be construed as unduly limiting of the present disclosure. All directional references (e.g., above, below, upper, lower, top, bottom, vertical, horizontal, inward, outward, radial, upward, downward, left, right, leftward, rightward, clockwise, and counter-clockwise) are only used for identification purposes to aid the reader's understanding of the present disclosure, and may not create limitations, particularly as to the position, orientation, or use of the systems and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations, components, and/or modifications of the present disclosure, and may not create any limitations, particularly as to the order, or preference, of any embodiment, variation, component and/or modification relative to, or over, another embodiment, variation, component and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims

### INDUSTRIAL APPLICABILITY

The plug 100 of the present disclosure has applicability for use and implementation in closing off apertures defined in various types of machine components. With use of the plug 100 disclosed herein, manufacturers of machine components can easily accomplish a closure of holes and/or apertures while saving costs, time, and/or effort previously incurred with use of conventional systems, structures or methods such as, but not limited to, inserts, material fillers, and the like.

With reference to various aspects of the present disclosure, it is hereby contemplated to manufacture the plug 100 from a soft material, metallic or non-metallic, such as, but limited to, plastic or aluminum. The soft material, disclosed herein, can be regarded as having a hardness lesser than that of the machine component 300. Although plastic and aluminum are disclosed herein, one of ordinary skill in the art will appreciate that other materials commonly known in the art can be optionally used in lieu of plastic and aluminum.

The soft nature of materials used in forming the plug 100 can beneficially allow some or more amount of deformation in the second set of threads 112 to occur upon engagement with the threads 306 of the machine component 300. Such deformation in the second set of threads 112 then facilitates the first portion 108 of the plug 100 to be snugly fit and hence, secured within the aperture 302 of the machine component 300.

Moreover, as the second portion 114 of the plug 100 shears away from the flange 102 at the neck portion 116, it is envisioned that the remainder of the plug 100 that stays within the machine component 300 cannot be disengaged , advertently or inadvertently, from the machine component 300. Therefore, the plug 100 can be beneficially used for closing off apertures that typically require permanent closure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A plug for closing an aperture defined in a machine component, the machine component having threads of a uniform pitch adjoining the aperture, the plug comprising:
a flange having a first side and a second side, wherein the first side of the flange is configured to abut an outer surface of the machine component disposed adjacent to the aperture;
a first portion extending axially away from the first side of the flange, wherein the first portion includes:
a first set of threads distally located from the first side of the flange, the first set of threads configured at a first pitch to threadably engage with the threads on the machine component;
a second set of threads continuously formed with the first set of threads and located proximal to the first side of the flange, wherein the second set of threads are configured at a second pitch that is different than the first pitch, the second set of threads configured to lock with the threads on the machine component so as to retain the first portion within the aperture; and
a second portion extending axially away from the second side of the flange, wherein the second portion includes;
a neck portion disposed on the second side of the flange, wherein the neck region is configured to withstand a maximum torque load; and
a bolt head extending from the neck portion, wherein the bolt head is operable to threadably engage the first set of threads and the second set of threads with the threads of the machine component and allow shearing of the neck portion if a torque applied on the bolt head exceeds the maximum torque load.
